(19) United States
(12) Patent Application Publication
(10) Pub. No.: US 2007/0291697 A1
(43) Pub. Date: Dec. 20, 2007

(54) METHOD FOR REPLACING MOBILE ROUTER IN MOBILE INTERNET SERVICE SYSTEM HAVING MULTIPLE MOBILE ROUTERS

(75) Inventors: EUN-KYOUNG PAIK, SEOUL (KR); HAN-LIM KIM, SEOUL (KR); SANG-EON KIM, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: KT CORPORATION, SEONGNAM-CITY (KR)

(21) Appl. No.: 11/767,332

(22) Filed: Jun. 22, 2007

Related U.S. Application Data
(63) Continuation of application No. PCT/KR05/04493, filed on Dec. 23, 2005.

(30) Foreign Application Priority Data
Dec. 23, 2004 (KR) 10-2004-0111219

(51) Int. Cl. H04Q 7/00

(52) U.S. Cl. 370/331

(57) ABSTRACT

Provided is a method for replacing a function of mobile router for a mobile Internet service in a multiple mobile router and multiple prefix structure. The method includes the steps of: at a second mobile router, detecting a malfunction of a first mobile router using a router notifying interval of the first mobile router when the first mobile router is malfunctioned; at the second mobile router, notifying the prefix of the first mobile router through the ingress Internet interface of the second mobile router; and at the second mobile router, registering prefix binding information of the first mobile router to the home agent through the egress Internet interface of the second mobile router.

### CROSS-REFERENCE TO RELATED PATENT APPLICATIONS

This application is a continuation application under 35 U.S.C. § 365(c) of International Application No. PCT/KR2005/004493, filed Dec. 23, 2005 designating the United States. International Application No. PCT/KR2005/004493 was published in English as WO2006/068446 A1 on Jun. 29, 2006. This application further claims the benefit of the earlier filing dates under 35 U.S.C. §365(b) of Korean Patent Application No. 10-2004-0111219 filed Dec. 23, 2004. This application incorporates herein by reference the International Application No. PCT/KR2005/004493 including the International Publication No. WO2006/068446 A1 and the Korean Patent Application No. 10-2004-0111219 in their entirety.

### BACKGROUND

1. Field

The present disclosure relates to a method for replacing a mobile router in a mobile Internet service system having multiple mobile routers, multiple prefixes, and a computer readable recording medium storing instructions to perform the same; and more particular, to a method for replacing a function of mobile router in a mobile Internet service system having multiple mobile routers and multiple prefixes, which enables other mobile routers to continuously perform a router advertisement function of a malfunctioned mobile router when a multiple mobile routers are managed according to a network mobility protocol that manages a mobility in a unit of network through forming a network with mobile Internet terminals move in a unit of group.

2. Discussion of the Related Technology

If one of mobile routers is malfunctioned while multiple mobile routers provide mobile Internet services to a mobile Internet terminal internally connected by notifying a difference prefix through an ingress Internet interface, the mobile Internet terminal cannot use the IP address which is set through the auto-configuration using the prefix notified by the malfunctioned mobile router. Therefore, the mobile Internet terminal must reconfigure other IP address using other prefix. Such a reconfiguration of IP address causes a time delay and the Internet service may be interrupted by the reconfiguration of IP address.

The foregoing discussion in this section is to provide general background information, and does not constitute an admission of prior art.

### SUMMARY

It is, therefore, an aspect of the present invention to provide a method for replacing a function of a mobile router for a mobile Internet service, which enables other mobile router to continuously notify a prefix of a malfunctioned mobile router when one of multiple mobile routers is malfunctioned wherein the mobile routers connect the Internet and the mobile Internet thermals moving in a unit of group, and a computer readable recording medium storing instructions to perform the same. In accordance with one aspect of the present invention, there is provided a method for replacing a function of mobile router in a mobile Internet service system having multiple mobile routers that receives a request for setting a mobile network address from multiple mobile Internet terminals, sets an address using prefixes of multiple mobile routers through an ingress Internet interface, sets a temporal address (care-of-address) of a moving location through an egress Internet interface and registering the temporal address to a home agent through the Internet, the method including the steps of: at a second mobile router, detecting a malfunction of a first mobile router using a router notifying interval of the first mobile router when the first mobile router is malfunctioned; at the second mobile router, notifying the prefix of the first mobile router through the ingress Internet interface of the second mobile router; and at the second mobile router, registering prefix binding information of the first mobile router to the home agent through the egress Internet interface of the second mobile router.

In accordance with another aspect of present invention, there is provided a computer readable recoding medium storing instructions to perform a method for replacing a function of mobile router in a mobile Internet service system having multiple mobile routers that receives a request for setting a mobile network address from multiple mobile Internet terminals, sets an address using prefixes of multiple mobile routers through an ingress Internet interface, sets a temporal address (care-of-address) of a moving location through an egress Internet interface and registering the temporal address to a home agent through the Internet, the method including the steps of: at a second mobile router, detecting a malfunction of a first mobile router using a router notifying interval of the first mobile router when the first mobile router is malfunctioned; at the second mobile router, notifying the prefix of the first mobile router through the ingress Internet interface of the second mobile router; and at the second mobile router, registering prefix binding information of the first mobile router to the home agent through the egress Internet interface of the second mobile router.

A method of replacing a function of mobile router in a mobile Internet service system having multiple mobile routers according to an embodiment of the present invention guarantees to maintain a connection between a mobile Internet terminal and Internet, constantly by implanting the method into a mobile router in a mobile Internet service network. Especially, the method of replacing a function of mobile router according to an embodiment of the present invention significantly increase a rate of accessing the service although a plurality of mobile Internet terminals travels with a train or a bus while related services are provided. Therefore, the related services are effectively provided and the mobile Internet service system is also effectively managed according to an embodiment of the present invention.

### DESCRIPTION OF THE DRAWINGS

The above and other aspects and features of the present invention will become apparent from the following description of embodiments given in conjunction with the accompanying drawings, in which:

FIG. 1 is a block diagram illustrating a mobile service system in accordance with an embodiment of the present invention; and

FIG. 2 is a view illustrating a method of replacing a function of mobile router in a mobile Internet service system having multiple mobile routers in according to an embodiment of the present invention.

### DETAILED DESCRIPTION OF EMBODIMENTS

Other aspects and features of the invention will become apparent from the following description of embodiments with reference to the accompanying drawings, which is set forth hereinafter.

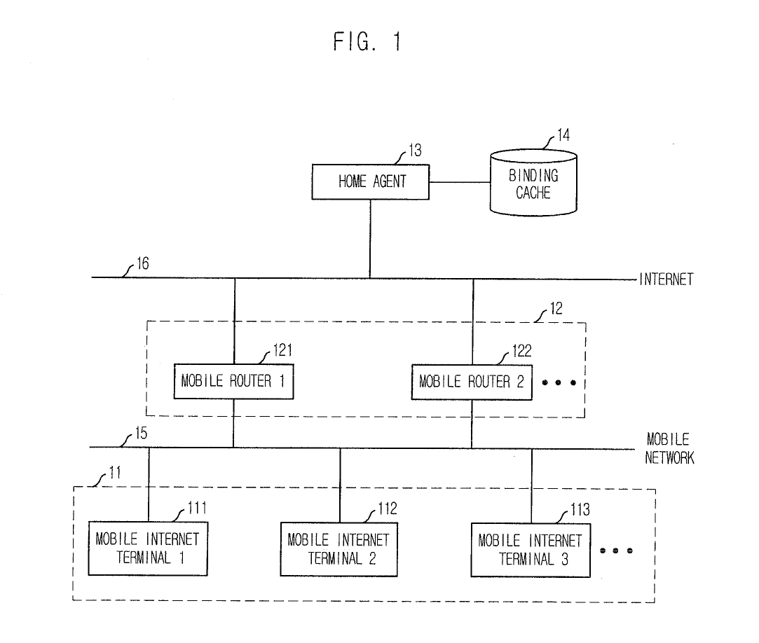

FIG. 1 is a block diagram illustrating a mobile service system in accordance with an embodiment of the present invention. As shown in FIG. 1, a numeral reference 11 denotes a mobile Internet terminal, a numeral reference 12 denotes a mobile router and a numeral reference 13 is a home agent. A numeral reference 14 is a binding cache, a numeral reference 15 is a mobile network and a numeral reference 16 represents the Internet. As shown, a plurality of mobile Internet terminals 111 and 112 is in the mobile service system as the multiple mobile Internet terminals 11, and a plurality of mobile routers 121 and 122 is also in the mobile service system as the multiple mobile routers 12.

FIG. 1 shows a location of a mobile router in a mobile Internet service network. The multiple mobile routers 12 manages a mobility of mobile Internet terminals 11 while connecting the multiple mobile Internet terminals 11 to the Internet 16 and traveling with the mobile Internet terminal 11. Therefore, the mobile Internet terminal 11 may freely travel and the home agent 13 enables to transmit a packet to all of the mobile Internet terminals included in a mobile network by registering the location of mobile network 15 to the binding caches 14 of the home agent 13 through the mobile router 12.

Accordingly, the first mobile router 121 and the second mobile router 122 notify different prefixes, the first mobile Internet terminal 111 sets an address using the prefix of the first mobile router 121 and the second mobile Internet terminal 112 sets an address using the prefix of the second mobile router 122.

If the first mobile router 121 is malfunctioned, the first mobile router 121 does not notify the prefix at a router notifying period. The second mobile router 122 stores the router notifying period and the prefix information of the first mobile router 121. If the first mobile router 121 does not notify at the router notifying period, the second router 122 detects that the first mobile router 121 is malfunctioned. Then, the second mobile router 122 takes over the functions of the first mobile router 121. Therefore, the mobile Internet terminal is not required to reconfigure the IP address although the mobile Internet terminal had the IP address using the prefix notified by the first mobile router 121.

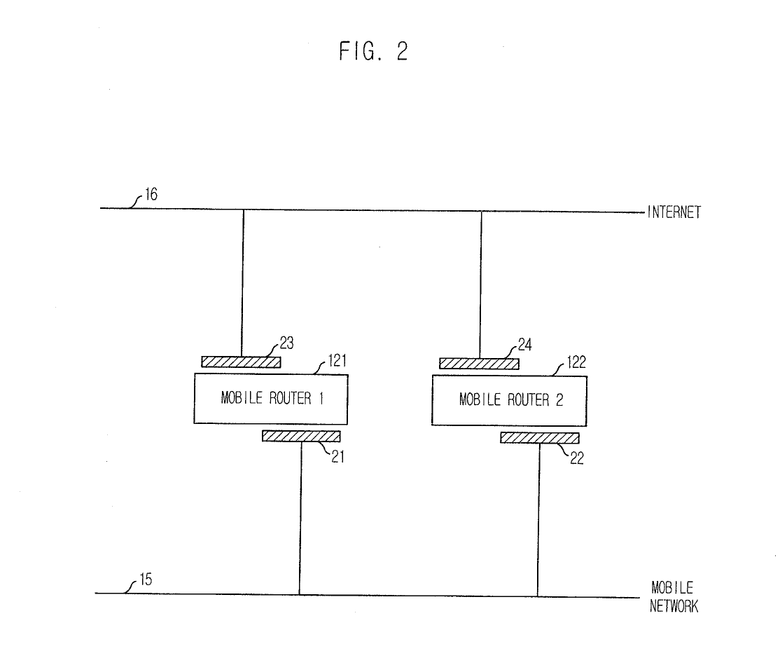

Hereinafter, the method of replacing a function of mobile router for a mobile Internet service in accordance with an embodiment of the present invention will be described with reference to FIG. 2. FIG. 2 is a view illustrating a method of replacing a function of mobile router in a mobile Internet service system having multiple mobile routers in according to an embodiment of the present invention. In FIG. 2, numeral references 121 and 122 denote a first mobile router and a second mobile router, respectively. Also, numeral references 21 and 22 denote the ingress Internet interfaces, and numeral reference 23 and 24 show the egress Internet interface.

As shown in FIG. 2, the first and the second mobile routers 121 and 122 manage two types of network interfaces. The ingress interfaces 21 and 22 notify a mobile network prefix to enable the mobile Internet terminal 11 to set an address of the mobile network 15.

Meanwhile, the egress interfaces 23 and 24 set a temporal address (care-of-address) at a moved location and register the care-of-address to the home agent 11. When the first mobile router 121 is malfunctioned, the second mobile router 122 notifies a prefix of the first mobile router 121 through the ingress interfaces 22 of the second mobile router 122 and registers the prefix binding information of the first mobile router 121 to the home agent 13 through the egress interface 24.

The multiple mobile routers 12 store information about router notifying period and prefix of other mobile routers included in the same mobile network. The multiple mobile routers 12 use the stored notifying cycle information to detect malfunctioning of other mobile router when the notifying message is transmitted.

As described above, the method of replacing the function of mobile router in a mobile Internet service system having multiple mobile routers according to an embodiment of the present invention enables a mobile router to notify a router advertisement instead of a malfunctioned mobile router. Therefore, the mobile internet terminal is not required to reconfigure the address although the mobile Internet terminal uses the IP based on the prefix notified by the malfunctioned mobile router. Therefore, the service is effective provided, and the system is also effectively controlled.

The above-described method according to an embodiment of the present invention can be embodied as a program and stored on a computer readable recording medium. The computer readable recording medium is any data storage device that can store data that can be thereafter read by the computer system. The computer readable recording medium includes a read-only memory (ROM), a random-access memory (RAM), a CD-ROM, a floppy disk, a hard disk and an optical magnetic disk.

While embodiments of the present invention has been described, it will be apparent to those skilled in the art that various changes and modifications may be made without departing from the scope of the invention as defined in the following claims.

What is claimed is:

1. A method for replacing a function of mobile router in a mobile Internet service system having multiple mobile routers that receives a request for setting a mobile network address from multiple mobile Internet terminals, sets an address using prefixes of multiple mobile routers through an ingress Internet interface, sets a temporal address (care-of-address) of a moving location through an egress Internet interface and registering the temporal address to a home agent through the Internet, the method comprising:
at a second mobile router, detecting a malfunction of a first mobile router using a router notifying interval of the first mobile router when the first mobile router is malfunctioned;
at the second mobile router, notifying the prefix of the first mobile router through the ingress Internet interface of the second mobile router; and
at the second mobile router, registering prefix binding information of the first mobile router to the home agent through the egress Internet interface of the second mobile router.

2. The method as recited in claim 1, wherein the multiple mobile router stores information about a router notifying period and a prefix of the other mobile routers in a same mobile network.

3. The method as recited in claim 1, wherein the multiple mobile router uses the stored information about the prefix and the notifying period to detect the malfunction of other mobile router.

4. The method as recited in claim 3, wherein the second mobile router allows the mobile Internet terminal not to reconfigure an IP address although the mobile Internet terminal configures the IP address using the prefix notified by the first mobile router by detecting the malfunction of the first mobile router if the first mobile router does not notify at the notifying period of the first mobile router and performing the functions of the first mobile router by storing the information about the prefix and the router notifying period of the first mobile router.

5. A computer readable recoding medium storing instructions to perform a method for replacing a function of mobile router in a mobile Internet service system having multiple mobile routers that receives a request for setting a mobile network address from multiple mobile Internet terminals, sets an address using prefixes of multiple mobile routers through an ingress Internet interface, sets a temporal address (care-of-address) of a moving location through an egress Internet interface and registering the temporal address to a home agent through the Internet, the method comprising:
at a second mobile router, detecting a malfunction of a first mobile router using a router notifying interval of the first mobile router when the first mobile router is malfunctioned;
at the second mobile router, notifying the prefix of the first mobile router through the ingress Internet interface of the second mobile router; and
at the second mobile router, registering prefix binding information of the first mobile router to the home agent through the egress Internet interface of the second mobile router.
